(19) United States
(12) Patent Application Publication
(10) Pub. No.: US 2011/0023603 A1
(43) Pub. Date: Feb. 3, 2011

(54) Method And Apparatus For Determining The Current Longitudinal Vehicle Speed

(75) Inventors: Andreas Abele, Barbing (DE); Matthias Kretschmann, Regensburg (DE)

Correspondence Address: King & Spalding LLP, 401 Congress Avenue, Suite 3200, Austin, TX, 78701, US

(73) Assignee: CONTINENTAL AUTOMOTIVE GMBH, Hannover (DE)

(21) Appl. No.: 12/438,211

(22) PCT Filed: May 29, 2007
(86) PCT No.: PCT/EP07/55193

§ 371 Date: Aug. 21, 2009

(30) Foreign Application Priority Data
Aug. 21, 2006 (DE) 10 2006 039 153.5

(51) Int. Cl. G01P 15/00

(52) U.S. Cl. 73/507

(57) ABSTRACT

A wheel rotation speed (RD) is determined from at least two wheels of a vehicle, respectively. A variable variability measure (VAR) is determined for each wheel rotation speed (RD), respectively. The current reliability of the respective wheel rotation speed (RD) is determined as a function of the variability measure (VAR). The current longitudinal vehicle speed is determined either as a function of the wheel rotation speeds (RD) which are currently detected as being reliable, or the current longitudinal vehicle speed is determined as an extrapolation as a function of wheel rotation speeds (RD) which were previously detected as being reliable if all wheel rotation speeds (RD) are currently detected as being unreliable.

### CROSS-REFERENCE TO RELATED APPLICATIONS

This application is a U.S. National Stage Application of International Application No. PCT/EP2007/055193 filed May 29, 2007, which designates the United States of America, and claims priority to German Application No. 10 2006 039 153.5 filed Aug. 21, 2006. The contents of these applications are incorporated herein in there entirety by reference.

### TECHNICAL FIELD

The invention relates to a method and a corresponding apparatus for determining the current longitudinal vehicle speed.

### BACKGROUND

In motor vehicles, driving dynamics algorithms are being used increasingly. A current state of movement of a motor vehicle is determined as a function of sensor signals. If required, controlling variables for controlling actuators are generated, for example to control the brakes of the motor vehicle, in order to be able to counteract undesired states of movement of the motor vehicle. A significant variable with regard to the current state of movement of the motor vehicle is the current longitudinal vehicle speed.

### SUMMARY

According to various embodiments, a method and a corresponding apparatus for determining a current longitudinal vehicle speed that is reliable can be provided.

According to an embodiment, a method for determining the current longitudinal vehicle speed, may comprise the steps:—a wheel rotation speed is determined from at least two wheels of a vehicle in each case,—a sliding measure of variability is determined for each wheel rotation speed in each case,—a current reliability of the respective wheel rotation speed is determined as a function of the measure of variability and—the current longitudinal vehicle speed is determined either as a function of the wheel rotation speeds that are currently detected as being reliable or the current longitudinal vehicle speed is determined as an extrapolation as a function of the wheel rotation speeds that were previously detected as being reliable, if all the wheel rotation speeds are currently detected as being unreliable.

According to a further embodiment, the measure of variability can be formed by means of a variance or a standard deviation. According to a further embodiment, a wheel acceleration can be determined for each wheel rotation speed in each case as a function of the respective wheel rotation speed and the current reliability of the respective wheel rotation speed can be determined as a function of the respective wheel acceleration. According to a further embodiment, the respective wheel rotation speed can be currently detected as being reliable when the measure of variability is lower than a predetermined variability threshold value and the respective wheel acceleration is greater than a predetermined lower wheel acceleration threshold value and is lower than a predetermined upper wheel acceleration threshold value. According to a further embodiment, the wheel acceleration can be determined for each wheel rotation speed in each case, a stationary state of the vehicle can be detected when all the wheel accelerations equal zero, and for determining the current longitudinal vehicle speed on a switch from a detected stationary state to a movement of the vehicle for a predetermined period of time, selecting the wheel rotation speed from the wheel rotation speeds currently detected as being reliable which has the lowest value. According to a further embodiment, the current longitudinal vehicle speed can be determined as a function of an average value of the wheel rotation speeds that are currently detected and if required selected as being reliable. According to a further embodiment, the wheel acceleration can be determined for each wheel rotation speed in each case, the stationary state of the vehicle can be detected when all the wheel accelerations equal zero, a minimum wheel rotation speed can be determined on a switch from a movement of the vehicle to the stationary state of the vehicle as a function of the wheel rotation speeds that were previously detected and if required selected as being reliable and the current longitudinal vehicle speed can be limited downwards by means of a longitudinal vehicle speed predetermined by a minimum wheel rotation speed. According to a further embodiment, the current longitudinal vehicle speed can be provided smoothed by means of a filter.

According to another embodiment, an apparatus for determining a current longitudinal vehicle speed, may be embodied—for determining a wheel rotation speed from at least two wheels of a vehicle in each case,—for determining a sliding measure of variability for each wheel rotation speed in each case,—for determining a current reliability of the respective wheel rotation speed as a function of the measure of variability and—for determining the current longitudinal vehicle speed either as a function of the wheel rotation speeds that are currently detected as being reliable or for determining the current longitudinal vehicle speed as an extrapolation as a function of the wheel rotation speeds that were previously detected as being reliable if all the wheel rotation speeds are currently detected as being unreliable.

### BRIEF DESCRIPTION OF THE DRAWINGS

The invention is described in more detail below with reference to an exemplary embodiment specified in the schematic figures of the drawing, in which:

FIG. 1 shows a vehicle with wheel rotation speed sensors and

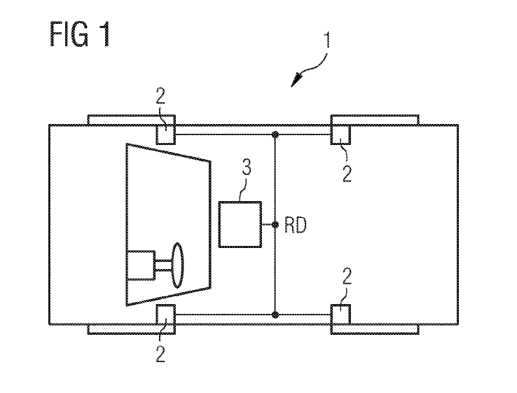

FIG. 2 a block diagram.

### DETAILED DESCRIPTION

According to various embodiments, in a method and a corresponding apparatus for determining a current longitudinal vehicle speed, a wheel rotation speed is determined from at least two wheels of a vehicle in each case. A sliding measure of variability is determined for each wheel rotation speed in each case. A current reliability of the respective wheel rotation speed is determined as a function of the measure of variability. The current longitudinal vehicle speed is determined either as a function of the wheel rotation speeds which are currently detected as being reliable, or the current longitudinal vehicle speed is determined as an extrapolation as a function of the wheel rotation speeds that were previously detected as being reliable if all the wheel rotation speeds are currently detected as being unreliable.

The advantage is that as a result the current longitudinal vehicle speed can be determined in a reliable manner as a function of the wheel rotation speeds. Besides the wheel rotation speeds, no further information of the sensors for determining the longitudinal vehicle speed is required. The reliability of the respective wheel rotation speed is determined by evaluating the measure of variability that represents a variability of a graph of the respective wheel rotation speed over time. In addition, the current longitudinal vehicle speed can be determined as a function of the drive concept of the vehicle, this means irrespective of the fact whether or not the vehicle is a front wheel drive, a rear wheel drive, or an all wheel drive. No assumptions need thus be made as to which of the at least two wheel rotation speeds are in principle suitable for the reliable determination of the longitudinal vehicle speed. The wheel rotation speeds of all the wheels of the vehicle can be taken into account irrespective of the drive concept. As a result, the method and the apparatus are easy to use for different vehicle types with a different drive concept.

In an embodiment, the measure of variability is formed by means of a variance or a standard deviation. This is particularly simple.

In a further embodiment, a wheel acceleration is in each case determined as a function of the respective wheel rotation speed for each wheel rotation speed. The current reliability of the respective wheel rotation speed is determined as a function of the respective wheel acceleration. This has the advantage that the reliability and, in this way, the current longitudinal vehicle speed can be determined in a particularly reliable and accurate manner.

Within this context, it is advantageous if the respective wheel rotation speed is currently detected as being reliable, if the measure of variability is smaller than a predetermined variability threshold value and the respective wheel acceleration is higher than a predetermined lower wheel acceleration threshold value and is lower than a predetermined upper wheel acceleration threshold value. In this way, the longitudinal vehicle speed can be determined in a particularly simple and reliable manner.

In a further embodiment, the wheel acceleration is determined for the wheel rotation speed in each case. The stationary state of the vehicle is detected if all the wheel accelerations equal zero. In order to determine the current longitudinal vehicle speed, when there is a switch from a detected stationary state to a movement of the vehicle for a predetermined period of time, the wheel rotation speed that is the lowest is selected from the wheel rotation speeds that are currently detected as being reliable. The advantage is that any increased slippage in acceleration of the vehicle does not negatively affect the determination of the current longitudinal vehicle speed, if required. This makes the current longitudinal vehicle speed determined particularly accurate and reliable.

In a further embodiment, the current longitudinal vehicle speed is identified as a function of an average value of the wheel rotation speeds that are currently detected as being reliable and if required selected wheel rotation speeds are determined. This is particularly simple.

In a further embodiment, the wheel acceleration is determined for each wheel rotation speed in each case. The stationary state of the vehicle is detected if all the wheel accelerations equal zero. A minimum wheel rotation speed is determined when there is a switch from a movement of the vehicle to the stationary state of the vehicle as a function of the wheel rotation speeds that were previously detected as being reliable and if required selected wheel rotation speeds are determined. The current longitudinal vehicle speed is limited at the bottom end by means of a longitudinal vehicle speed predetermined by the minimum wheel rotation speed. The advantage is that the minimum wheel rotation speed can be determined easily and reliably as a result of this. This is in particular advantageous if the wheel rotation speed sensors of the vehicle cannot detect, determined by the design, random small wheel rotation speeds and in particular also not a zero wheel rotation speed. By automatically determining the minimum wheel rotation speeds, these do not have to be predetermined.

In a further embodiment, the current longitudinal vehicle speed is provided in a smoothed manner through a filter. The advantage is that by means of the smoothing process, the determined longitudinal vehicle speed corresponds better to an actual longitudinal vehicle speed of the motor vehicle.

On the basis of changes in current reliability of the wheel rotation speeds the longitudinal vehicle speed is determined, if required, on the basis of different combinations of the wheel rotation speeds. This can lead to jumps, which can easily be reduced by means of the smoothing process.

Elements with the same construction or function are provided with the same reference characters throughout all the figures.

The vehicle 1 has a wheel rotation speed sensor 2 on each wheel. The wheel rotation speed sensors 2 are coupled to an evaluating apparatus 3. As a function of a measurement signal of the respective wheel rotation speed sensors 2, a wheel rotation speed RD is determined for each wheel as a signal varying over time.

The respective wheel rotation speed RD is either determined by means of the respective wheel rotation speed sensor 2 and is fed into the evaluating apparatus 3 or is determined in the evaluating apparatus 3 from the measurement signal of the respective wheel rotation speed sensor 2, which is fed into the evaluating apparatus 3. The evaluating apparatus 3 can also be referred to as an apparatus for determining a current longitudinal vehicle speed.

The wheels in each case comprise a transmitting wheel with teeth that jointly rotate with the respective wheel. The wheel rotation speed sensors 2 are for example embodied to detect the rotation of the transmitting wheel and to produce the measurement signal as a function of an alternation between the tooth and the tooth gap and an alternation between the tooth gap and the tooth. The wheel rotation speed RD of the respective wheel of the vehicle 1 can be determined by means of counting the teeth of this alternation within a given determination period of time. However, the wheel rotation speed sensors 2 can also be embodied in a different manner. The wheel rotation speed RD can also be designated as the speed of the wheel.

With this type of determination of the respective wheel rotation speed RD, very low wheel rotation speeds RD cannot be determined. In the case of very low wheel rotation speeds RD, a period of time between two alternations is longer than that of the predetermined determination period. As a result, random low wheel rotation speeds RD cannot be identified. In particular, a wheel rotation speed RD of zero cannot be determined.

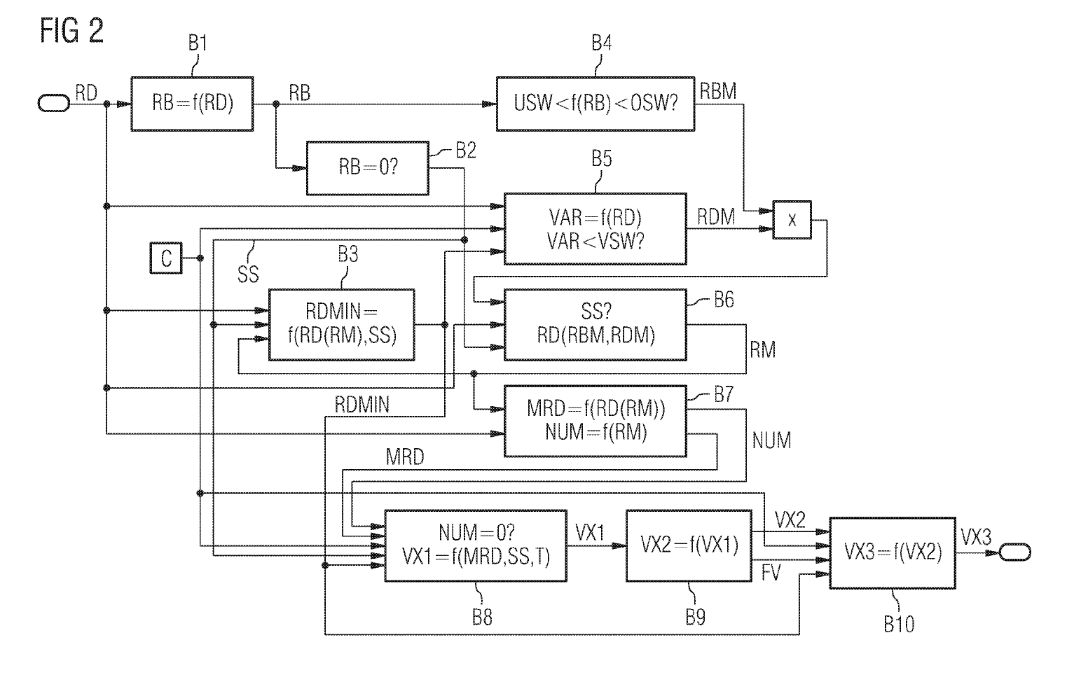

FIG. 2 shows a block diagram of a method for determining the current longitudinal vehicle speed as a function of the wheel rotation speeds RD. The method has for example been implemented as a program in the evaluating apparatus 3, that can be executed by the latter. In the block diagram, the wheel rotation speeds RD are interpreted as a vector, which includes the wheel rotation speeds RD of the individual wheels of the vehicle 1 as elements. This vector of the wheel rotation speeds RD forms an input variable in the block diagram.

The wheel rotation speeds RD are fed into a block B1. In block B1, a wheel acceleration RB is determined as a function of the wheel rotation speeds RD. To this end, a differential quotient is for example formed in each case from consecutive wheel rotation speed values of the respective wheel rotation speed RD. The wheel accelerations RB determined for the respective wheels in each case preferably form a vector, the elements of which are formed by means of the respective wheel accelerations RB of all the wheels of the vehicle 1.

The wheel accelerations RB are fed into a second block B2. A stationary state detection is carried out in the second block B2. A stationary state SS of the vehicle 1 is for example detected if the wheel acceleration RB equals zero for all the wheels of the vehicle 1. Else it is assumed that that the vehicle 1 is moving.

In a block B3, a minimum wheel rotation speed RDMIN is determined as a function of the wheel rotation speeds RD and the stationary state SS. When the movement of the vehicle 1 switches to the stationary state SS of the vehicle 1, the minimum wheel rotation speed RDMIN is determined for example as a function of the wheel rotation speeds RD that were determined immediately before the switch to the stationary state SS. In this way, by means of block B3, the minimum wheel rotation speed RDMIN can automatically be determined so that this does not have to be predetermined.

If the wheel rotation speeds RD are for example determined as described above by evaluating the switch between the teeth and the teeth gaps of the respective transmitting wheel and as a result of this random low wheel rotation speeds RD cannot be determined, then a longitudinal vehicle speed of for example zero is not physically supported by the measurement signals of the wheel rotation speed sensors 2. To this end, the determined minimum wheel rotation speed RDMIN can be used to limit the longitudinal vehicle speed that was determined by the method below, and by doing this, to ensure that the determined longitudinal vehicle speed physically corresponds with the determined wheel rotation speeds RD.

The wheel accelerations RB are also fed into a fourth block B4. The wheel rotation speed RD that is appropriate for the respective wheel acceleration RB is detected as being unreliable in a block B4, if a vehicle acceleration corresponding to the respective wheel acceleration RB leaves a predetermined, physical meaningful range of values. The respective wheel rotation speed RD is detected as being unreliable, if the associated wheel acceleration RB in each case is lower than or equal to a predetermined lower wheel acceleration threshold value USW or is higher than or equals a predetermined upper wheel acceleration threshold value OSW. The predetermined lower wheel acceleration threshold value USW for example corresponds to a vehicle acceleration of −1.5 g and the predetermined upper wheel acceleration threshold value OSW to a vehicle acceleration of +2 g, with g standing for an acceleration due to gravity of approximately 9.81 m/s². However, the predetermined lower wheel acceleration threshold value USW and the predetermined upper wheel acceleration threshold value OSW can also be predetermined in a different way.

On the output side, a wheel acceleration indicator RBM is provided in a block B4, which represents the reliability of the respective wheel rotation speed RD with reference to the wheel acceleration RB. The wheel acceleration indicator RBM for example is a vector, which has a one as element for each wheel rotation speed RD detected in a block B4 as being reliable and a zero as element for each wheel rotation speed RD detected in a block B4 as being unreliable. However, the wheel acceleration indicator RBM can also be designed in a different way.

In addition, the wheel rotation speeds RD are also checked in a block B5 for their reliability. To this end, a measure of variability VAR is determined in a variable manner over time for each wheel rotation speed RD. The measure of variability VAR is for example formed by means of a variance or a standard deviation. The measure of variability VAR is preferably only determined when a sum of the respective wheel rotation speed RD is greater than the minimum wheel rotation speed RDMIN. If all the wheel rotation speeds RD are below a predetermined wheel rotation speed threshold value, then only the lowest wheel rotation speed RD is detected as being reliable in a preferred manner.

The respective wheel rotation speed RD is detected as being unreliable when the associated measure of variability VAR is greater than or equals a predetermined variability threshold value VSW, and is detected as being reliable when the measure of variability VAR is lower than the predetermined variability threshold value VSW. According to the RBM, the wheel acceleration indicator is provided by means of a block B5 to a wheel rotation speed indicator RDM, which represents the reliability of the respective wheel rotation speed RD with reference to the measure of variability VAR.

The wheel acceleration indicator RBM and the wheel rotation speed indicator RDM are linked with one another, for example by means of multiplication, and subsequently fed into a block B6. In a block B6, a check is carried out in order to determine whether or not there is an switch from the stationary state SS to the movement of the vehicle 1. Should this alternation exist, then it is assumed that the vehicle 1 is accelerating. However, on accelerating, a higher slippage of the driven wheels of the vehicle 1 often occurs. Because of said slippage, the respective wheel rotation speed RD of these wheels is for example higher if required, than it might have been with reference to a current longitudinal vehicle speed of the vehicle 1.

For this reason, after the alternation from a stationary state SS to a movement of the vehicle 1 for a predetermined period of time, for example for a few seconds, only that wheel rotation speed RD that is the lowest is selected from the wheel rotation speeds RD that are currently detected as being reliable. According to the wheel acceleration indicator RBM and the wheel rotation speed indicator RDM, this wheel rotation speed RD is represented by means of a wheel indicator RM, which is provided at the output end of a block B6. For example, only the element of the vector associated with the selected wheel rotation speed RD shows a one while all the other elements of the vector show a zero. After the expiry of the predetermined period of time, the wheel indicator RM preferably corresponds to the linking of the wheel acceleration indicator RBM and the wheel rotation speed indicator RDM.

The wheel indicator RM is also supplied to a block B3. The minimum wheel rotation speed RDMIN is only preferably determined from the wheel rotation speeds RD that were previously detected as being reliable and if required selected, for example by creating average values of these wheel rotation speeds RD. As a result of this, the minimum wheel rotation speed RDMIN can be determined in a particularly reliable and accurate manner.

In a block B7, an average wheel rotation speed MRD is determined as a function of the wheel rotation speeds RD that are detected as being reliable or the wheel rotation speed RD selected according to the wheel indicator RM in question. The average wheel rotation speed MRD is for example determined as the arithmetic mean from the wheel rotation speeds RD indicated by the wheel indicator RM as being reliable or selected accordingly. In addition, a number NUM of the wheel rotation speeds RD used is determined as a function of the wheel indicator RM. The number NUM of the wheel rotation speeds RD used is for example determined as the sum of all the elements of the wheel indicator RM. In addition, if the number NUM of the wheel rotation speeds RD used equals zero, this means that no average wheel rotation speed MRD can currently be determined and then the average wheel rotation speed MRD determined immediately prior to this is preferably provided at the output end of a block B7.

The average wheel rotation speed MRD and the number NUM of the wheel rotation speeds RD used is fed into a block B8. A first speed VX1 is determined in a block B8 and is provided at the output end to a block B8. If the number NUM of the wheel rotation speeds RD used is greater than one or equals one, then the first speed VX1 is determined as a function of the average wheel rotation speed MRD determined, for example by means of multiplying by a predetermined wheel circumference.

However, if the number NUM of the wheel rotation speeds RD used equals zero, then the first speed VX1 is determined as an extrapolation as a function of the wheel rotation speeds RD that have previously been detected as being reliable and a time T. A further curve of the first speed VX1 is preferably approximated by means of a series development. In the case of a series development, the first speed VX1 that was previously determined from the average wheel rotation speed MRD, a vehicle acceleration that was previously determined from this and a derivation of this vehicle acceleration over time are preferably taken into consideration, for example by forming a further differential quotient. However, a linear extrapolation can likewise be carried out instead of the series development.

A previously determined curve of the first speed VX1, which was determined from the average wheel rotation speed MRD, and a vehicle acceleration curve developed from it are preferably smoothed by means of filtering. As a result, the possibility of differentiation of these curves can be ensured. In addition, an error is preferably corrected, in particular an amplitude displacement, which can be caused as a result of the fact that by means of filtering, there is a displacement over time between the smoothed and the unsmoothed curves respectively. To this end, at the beginning of the extrapolation, a difference is for example determined from a final value of the smoothed curve of the first speed VX1 and a final value of the unsmoothed curve of the first speed VX1. This difference forms the amplitude displacement, which is taken into account for the subsequently extrapolated values of the first speed VX1 for example by subtracting the amplitude displacement.

When switching from the movement of the vehicle 1 to the stationary state SS, a vehicle acceleration value determined immediately prior to this is preferably stored. A variable can be derived from this value, which represents a coefficient of friction of the wheels on a current highway. Should the braking action for example be carried out on a surface of ice, resulting in the wheels locking, this means the stationary state SS is detected and then the vehicle acceleration value determined immediately prior to this corresponds to a maximum possible acceleration on the surface of ice. Under the assumption that the current coefficient of friction further on the highway, in essence, remains unchanged while the first speed VX1 is determined by means of the extrapolation, this maximum possible acceleration can be used for the extrapolation, for example by means of correspondingly limiting a range of values of the vehicle acceleration.

The first speed VX1 is fed into a block B9, in which the first speed VX1 is smoothed by means of filtering. The first speed VX1 is in particular smoothed by means of a low-pass filter. As a result of the smoothing, jumps in the curve of the first speed VX1 can be reduced, which can for example arise by means of switches to the wheel rotation speeds RD used corresponding to the wheel indicator RM. This leads to an alternated basis of calculation for determining the average wheel rotation speed MRD. The first speed VX1 filtered in a block B9 is provided as a second speed VX2 at the output end of a block B9. In addition, a filtering delay FV of the filter is provided at the output end of a block B9. The filtering delay FV represents a phase distortion, which arises by filtering between the first speed VX1 and the second speed VX2.

This phase distortion is corrected in a block B10 to which the second speed VX2 and the filtering delay FV are fed. In addition, the minimum wheel rotation speed RDMIN is fed into a block B10. A third speed VX3 provided at the output end of a block B10, which represents the current longitudinal vehicle speed, is preferably limited downward by a longitudinal vehicle speed that corresponds with the minimum wheel rotation speed RDMIN. As a result, it is ensured that the third speed VX3 only represents such current longitudinal vehicle speeds as are supported physically by the wheel rotation speeds RD.

A constant C can be provided, which represents a time interval between two sampled values of the wheel rotation speed RD in each case. The constant C is for example fed into a block B5, a block B8 and a block B10. The constant C can be predetermined in accordance with the information about the respective vehicle in question.

The current longitudinal vehicle speed can also be determined in a different way. In essence, only a block B5 for determining the reliability of the wheel rotation speeds RD, a block B7 for determining the average wheel rotation speed MRD and the number NUM of the wheel rotation speeds RD used as a function of the wheel rotation speeds RD and the wheel rotation speed indicator RDM and a block B8 for determining the first speed VX1 are for example provided, which then represent the current longitudinal vehicle speed. In addition, further blocks can be provided as required in order to be able to determine the current longitudinal vehicle speed in a more reliable manner. The minimum wheel rotation speed RDMIN is for example only required when the wheel rotation speed sensors 2 cannot detect random low wheel rotation speeds RD. In this case, as an alternative to block B3, the minimum wheel rotation speed RDMIN can also be predetermined as a further constant.

What is claimed is:

1. A method for determining the current longitudinal vehicle speed, comprising the steps of:
determining a wheel rotation speed from at least two wheels of a vehicle, respectively,
determining a sliding measure of variability for each wheel rotation speed, respectively,
determining a current reliability of the respective wheel rotation speed as a function of the measure of variability, and
determining the current longitudinal vehicle speed either as a function of the wheel rotation speeds that are currently detected as being reliable or determining the current longitudinal vehicle speed as an extrapolation as a function of the wheel rotation speeds that were previously detected as being reliable, if all the wheel rotation speeds are currently detected as being unreliable.

2. The method according to claim 1, wherein the measure of variability is formed by means of a variance or a standard deviation.

3. The method according to claim 1, wherein
a wheel acceleration is determined for each wheel rotation speed, respectively as a function of the respective wheel rotation speed, and
the current reliability of the respective wheel rotation speed is determined as a function of the respective wheel acceleration.

4. The method according to claim 3, wherein the respective wheel rotation speed is currently being detected as being reliable when the measure of variability is lower than a predetermined variability threshold value and the respective wheel acceleration is greater than a predetermined lower wheel acceleration threshold value and is lower than a predetermined upper wheel acceleration threshold value.

5. The method according to claim 1, wherein
the wheel acceleration is determined for each wheel rotation speed, respectively,
a stationary state of the vehicle is detected when all the wheel accelerations equal zero, and
for determining the current longitudinal vehicle speed on a switch from a detected stationary state to a movement of the vehicle for a predetermined period of time, selecting the wheel rotation speed from the wheel rotation speeds currently detected as being reliable which has the lowest value.

6. The method according to claim 1, wherein the current longitudinal vehicle speed is determined as a function of an average value of the wheel rotation speeds that are currently detected and if required selected as being reliable.

7. The method according to claim 1, wherein
the wheel acceleration is determined for each wheel rotation speed, respectively,
the stationary state of the vehicle is detected when all the wheel accelerations equal zero,
a minimum wheel rotation speed is determined on a switch from a movement of the vehicle to the stationary state of the vehicle as a function of the wheel rotation speeds that were previously detected and if required selected as being reliable, and
the current longitudinal vehicle speed is limited downwards by means of a longitudinal vehicle speed predetermined by a minimum wheel rotation speed.

8. The method according to claim 1, wherein the current longitudinal vehicle speed is provided smoothed by means of a filter.

9. An apparatus for determining a current longitudinal vehicle speed, comprising:
means for determining a wheel rotation speed from at least two wheels of a vehicle, respectively,
means for determining a sliding measure of variability for each wheel rotation speed, respectively,
means for determining a current reliability of the respective wheel rotation speed as a function of the measure of variability, and
means for determining the current longitudinal vehicle speed either as a function of the wheel rotation speeds that are currently detected as being reliable or for determining the current longitudinal vehicle speed as an extrapolation as a function of the wheel rotation speeds that were previously detected as being reliable if all the wheel rotation speeds are currently detected as being unreliable.

10. A system for determining the current longitudinal vehicle speed, comprising:
wheel rotation speed sensors for at least two wheels of a vehicle, and
an evaluation unit operable:
to determine a sliding measure of variability for each wheel rotation speed, respectively,
to determine a current reliability of the respective wheel rotation speed as a function of the measure of variability, and
to determine the current longitudinal vehicle speed either as a function of the wheel rotation speeds that are currently detected as being reliable or to determine the current longitudinal vehicle speed as an extrapolation as a function of the wheel rotation speeds that were previously detected as being reliable, if all the wheel rotation speeds are currently detected as being unreliable.

11. The system as claimed in claim 10, wherein the measure of variability is formed by means of a variance or a standard deviation.

12. The system as claimed in claim 10, wherein
a wheel acceleration is determined for each wheel rotation speed in each case as a function of the respective wheel rotation speed and
the current reliability of the respective wheel rotation speed is determined as a function of the respective wheel acceleration.

13. The system as claimed in claim 12, wherein the respective wheel rotation speed is currently being detected as being reliable when the measure of variability is lower than a predetermined variability threshold value and the respective wheel acceleration is greater than a predetermined lower wheel acceleration threshold value and is lower than a predetermined upper wheel acceleration threshold value.

14. The system as claimed in claim 10, wherein
the wheel acceleration is determined for each wheel rotation speed, respectively,
a stationary state of the vehicle is detected when all the wheel accelerations equal zero, and
for determining the current longitudinal vehicle speed on a switch from a detected stationary state to a movement of the vehicle for a predetermined period of time, selecting the lowest wheel rotation speed from the wheel rotation speeds currently detected as being reliable.

15. The system as claimed in claim 10, wherein the current longitudinal vehicle speed is determined as a function of an average value of the wheel rotation speeds that are currently detected and if required selected as being reliable.

16. The system as claimed in claim 10, wherein
the wheel acceleration is determined for each wheel rotation speed, respectively,
the stationary state of the vehicle is detected when all the wheel accelerations equal zero,
a minimum wheel rotation speed is determined on a switch from a movement of the vehicle to the stationary state of the vehicle as a function of the wheel rotation speeds that were previously detected and if required selected as being reliable and
the current longitudinal vehicle speed is limited downwards by means of a longitudinal vehicle speed predetermined by a minimum wheel rotation speed.

17. The system as claimed in claim 10, wherein the current longitudinal vehicle speed is provided smoothed by means of a filter.
